(19) United States
(12) Patent Application Publication
(10) Pub. No.: US 2024/0349747 A1
(43) Pub. Date: Oct. 24, 2024

(54) CONCENTRATED COFFEE IN SINGLE-SERVING CONTAINER AND METHOD FOR MANUFACTURING THE SAME

(71) Applicant: MELODIAN CO., LTD., Yao-shi, Osaka (JP)

(72) Inventors: Masato ITO, Yao-shi, Osaka (JP); Ryoko IDE, Yao-shi, Osaka (JP)

(73) Assignee: MELODIAN CO., LTD., Yao-shi, Osaka (JP)

(21) Appl. No.: 18/683,362

(22) PCT Filed: Dec. 9, 2021
(86) PCT No.: PCT/JP2021/045374

§ 371 Date: Feb. 13, 2024

(51) Int. Cl. A23F 5/28

(52) U.S. Cl. CPC A23F 5/28

(57) ABSTRACT

A concentrated coffee in single-serving container product and a method for manufacturing the product. An accommodation part of the container is filled with a concentrated coffee liquid. An opening of the accommodation part is sealed with a peelable lid material. The method includes blending a concentrated coffee liquid and a stabilizer, homogenizing the concentrated coffee liquid after the blending, a primary sterilization of the concentrated coffee liquid after the homogenizing, filling the accommodation part with the concentrated coffee liquid after the primary sterilization and sealing of the opening with the lid material, and a secondary sterilization of the concentrated coffee in single-serving container after the filling. In the filling step, a space other than that filled by the concentrated coffee liquid in the accommodation part is filled with an inert gas.

### TECHNICAL FIELD

The present invention relates to a concentrated coffee in single-serving container, and more particularly to a concentrated coffee in single-serving container that prevent spilling when unsealed, is excellent in preservability, and preserves the distinctive flavor of coffee for a long period of time, and a method for manufacturing the same.

### BACKGROUND ART

Coffee is generally distributed in the form of coffee beans, brewed coffee, instant coffee and liquid coffee (coffee extract, concentrated coffee liquid). In the past, instant coffee was preferred as an easy-to-drink form, but in recent years, demands for coffee beans and brewed coffee have been increasing due to the diversification of consumer tastes. Furthermore, the demand for a concentrated coffee in small containers is also increasing because of quick and easy to prepare, a rich aroma than instant coffee, and a taste similar to that of brewed coffee. Small containers of a concentrated coffee are filled with a concentrated coffee liquid for single use. A concentrated coffee in a small container can be easily made into hot coffee, iced coffee, caffe latte, etc. by pouring a concentrated coffee liquid in a cup and adding hot water, cold water, or milk.

For example, Patent Literature 1 discloses a concentrated coffee in a small container in which a coffee concentrate equivalent to one cup is filled in a container consisting of a small container body molded of a synthetic resin impermeable to volatile gas flavor constituents and containing a predetermined small amount of coffee concentrate, and a sheet-like lid heat-sealed to the main body of the small container containing a coffee concentrate.

### CITATION LIST

### Patent Litrature

[PTL 1] JP-A No. H2-219542

[PTL 2] JP-A No. H4-45745

### SUMMARY OF INVENTION

### Technical Problem

However, the concentrated coffee in a small container of Patent Litrature 1 has a problem that when a container is fully filled with a concentrated coffee liquid to prevent the oxidation of the concentrated coffee liquid and the leakage of aroma components, the concentrated coffee liquid spills at the time of opening. To solve this problem, a space is provided between the lid and the surface of the concentrated coffee liquid to prevent the concentrated coffee liquid from spilling. However, a space between the lid and the surface of the concentrated coffee liquid causes a problem that the oxygen in the space oxidizes the concentrated coffee liquid and such coffee liquid is not suited for long-term storage. Furthermore, the space between the lid and the surface of the concentrated coffee liquid causes a problem that the aroma components of the coffee flow out into the space, making it impossible to preserve the flavor for a long period of time.

In addition, the concentrated coffee liquid obtained by extracting coffee beans with hot water contains soluble dietary fiber, and since the components with a precipitation property are excessive due to concentration, precipitation tends to occur when stored for a long time. When precipitates occur in the concentrated coffee liquid, the coffee liquid has a rough feeling during drinking, resulting in a bad mouthfeel. In order to solve these problems, Patent Literature 2 discloses a method for preventing precipitation by mixing a fiber degrading enzyme with a coffee extract. However, the mixing of a fiber degrading enzyme brings a problem that the concentrated coffee liquid has an off-taste.

Therefore, the main purpose of the present invention is to provide a concentrated coffee in single-serving container that prevents spilling when unsealed, has an excellent preservability, and preserves the distinctive flavor of coffee for a long period of time, and a method for manufacturing the same.

### Solution to Problem

The method for manufacturing a concentrated coffee in single-serving container according to the present invention is a method for manufacturing a concentrated coffee in single-serving container in which a predetermined amount of a concentrated coffee liquid is filled in an accommodation part of a cup-shaped single-serving container, and an opening of the accommodation part is sealed with a peelable lid material, including a blending step of mixing an unprocessed concentrated coffee stock liquid and a stabilizer to prepare a concentrated coffee liquid, a homogenization step of homogenizing the concentrated coffee liquid obtained by the blending step, a primary sterilization step of sterilizing the concentrated coffee liquid homogenized in the homogenization step, a filling step of filling the concentrated coffee liquid sterilized in the primary sterilization step in an accommodation part molded of a container molding material having a gas barrier property, and sealing the opening of the accommodation part with the lid material having a gas barrier property, and a secondary sterilization step of sterilizing the single-serving container filled with the concentrated coffee liquid in the filling step, wherein, after filling the accommodation pat of the single-serving container with the concentrated coffee liquid sterilized in the primary sterilization step, in the filing step, a space other than the concentrated coffee liquid in the accommodation part is filled with an inert gas, and then the opening of the accommodation part is sealed with a lid material.

According to the method for manufacturing a concentrated coffee in single-serving container of the present invention, spilling of the concentrated coffee liquid at the time of opening can be prevented because the single-serving container is provided with a space other than the concentrated coffee liquid. In addition, filling the space of the accommodation part of the single-serving container with an inert gas enables the filled concentrated coffee liquid to prevent oxidative deterioration. In addition, precipitation of the concentrated coffee liquid can be reduced because the concentrated coffee liquid is mixed with a stabilizer. Since precipitation of the concentrated coffee liquid can be reduced, it enables the mouthfeel during drinking and the preservability to improve. Further, a material of the accommodation part and lid material of the single-serving container has a gas barrier property, which prevents the inflow of oxygen and prevents the leakage of the distinctive aroma components of coffee to the outside of the single-serving container and the lid material, therefore, the distinctive flavor of coffee can be maintained for a long period of time.

The method for manufacturing a concentrated coffee in single-serving container according to the present invention further incudes a secondary homogenization step of homogenizing the concentrated coffee liquid sterilized in the primary sterilization step, wherein the concentrated coffee liquid homogenized in the secondary homogenization step is filled in the filling step.

According to the method for manufacturing a concentrated coffee in single-serving container of the present invention, the particles can be made uniform again by performing the homogenization step after the primary sterilization step. Therefore, precipitation of the concentrated coffee liquid is less likely to occur, and the stability of the concentrated coffee liquid can be further improved.

The method for manufacturing a concentrated coffee in single-serving container according to the present invention includes that the stabilizer is mixed with the unprocessed concentrated coffee liquid at a ratio of 0.54% or more and 0.83% or less in the blending step.

According to the method for manufacturing a concentrated coffee in single-serving container of the present invention, the stabilizer is mixed with the unprocessed concentrated coffee liquid at a ratio of 0.54% or more and 0.83% or less, thereby precipitation can be prevented without affecting the feeling on the tongue and flavor.

The method for manufacturing a concentrated coffee in single-serving container according to the present invention includes that the stabilizer is microcrystalline cellulose. According to the method for manufacturing a concentrated coffee in single-serving container of the present invention, since microcrystalline cellulose is used as a stabilizer, precipitation can be prevented without affecting flavor.

The method for manufacturing a concentrated coffee in single-serving container according to the present invention further includes a packaging step after the secondary sterilization step, wherein the packaging step includes a step of packaging a plurality of concentrated coffees in the single-serving containers in an outer bag provided with a light-shielding film.

According to the method for manufacturing a concentrated coffee in single-serving container of the present invention, deterioration due to light can be prevented by packaging in an outer bag provided with a light-shielding film. In particular, the concentrated coffee in the single-serving container is manufactured using the single-serving container and a film for the lid material both having a light-shielding property, and is further packaged in an outer bag having the light-shielding property. Therefore, the light-shielding property of the self-serving container, the lid material, and the outer bag can be prevented from deterioration due to light.

The concentrated coffee in single-serving container according to the present invention is that a predetermined amount of a concentrated coffee liquid is filled in an accommodation part of a cup-shaped single-serving container, and the opening of the accommodation part is sealed with a peelable lid material. Further, the concentrated coffee liquid contains a stabilizer, the single-serving serving container and the lid material are formed from a material having a gas barrier property, the accommodation part is provided with a space other than the concentrated coffee liquid, the space is filled with an inert gas, and the residual oxygen concentration is less than 1% in the space when the product is completed.

According to the concentrated coffee in single-serving container of the present invention, spilling of the concentrated coffee liquid at the time of opening can be prevented because the single-serving container is provided with a space other than the concentrated coffee liquid. In addition, filling the space of the accommodation part of the single-serving container with an inert gas enable the filled concentrated coffee liquid to prevent oxidative deterioration. In addition, the concentrated coffee liquid is mixed with a stabilizer, which can reduce precipitation of the concentrated coffee liquid. Since precipitation of the concentrated coffee liquid can be reduced, it enables improvement of the mouthfeel during drinking and the preservability. Furthermore, a material of the accommodation part and the lid material of the single-serving container has a gas barrier property, which prevents the inflow of oxygen and reduces the leakage of the distinctive aroma components of coffee to the outside of the single-serving container, therefore, the distinctive flavor of coffee can be preserved for a long time.

The concentrated coffee in single-serving container according to the present invention is characterized in that the single-serving container and the lid material are formed from a light-shielding material.

According to the concentrated coffee in single-serving container of the present invention, deterioration due to light can be prevented by using light-shielding materials for the single-serving container and the lid material.

The stabilizer for a concentrated coffee in single-serving container according to the present invention is mixed at a ratio of 0.54% or more and 0.83% or less with respect to the unprocessed concentrated coffee liquid.

According to the concentrated coffee in single-serving container of the present invention, mixing the stabilizer in a ratio of 0.54% or more and 0.83% or less with respect to the unprocessed concentrated coffee liquid can prevent precipitation without affecting the feeling on the tongue and flavor.

### Advantageous Effect of the Invention

According to the present invention, the concentrated coffee in single-serving container and the method therefor can provide a manufacturing method that prevents spilling at the time of opening, has excellent in preservability, and preserves the distinctive flavor of coffee for a long period of time.

The above object, other objects, features and advantages of the present invention will become more apparent from the following description of embodiment with reference to the drawings.

### BRIEF DESCRIPTION OF DRAWINGS

FIG. 1 is an illustrative front view of a concentrated coffee in single-serving container according to an embodiment of the present invention.

FIG. 2 is an illustrative plan view of a concentrated coffee in single-serving container according to an embodiment of the present invention.

FIG. 3 is an illustrative cross-sectional view of the concentrated coffee in single-serving container taken along line III-III in FIG. 2.

FIG. 4 is an illustrative cross-sectional view of the single-serving container along line III-III in FIG. 2.

FIG. 5 is a flow chart showing a method for manufacturing a concentrated coffee in single-serving container according to an embodiment of the present invention.

FIG. 6 is an illustrative view showing a method for manufacturing a concentrated coffee in single-serving container according to an embodiment of the present invention.

FIG. 7 is an illustrative view showing a device for filling a concentrated coffee in single-serving container according to an embodiment of the present invention.

FIG. 8 is an illustrative plan view of a device for filling a concentrated coffee in single-serving container according to an embodiment of the present invention.

FIG. 9 is an illustrative cross-sectional view taken along line IX-IX in FIG. 8.

FIG. 10 is an illustrative cross-sectional view taken along line X-X in FIG. 9.

FIG. 11 is a view showing the results of a long-term storage test.

FIG. 12 is a view showing the results of a flavor test using a taste sensor.

FIG. 13 is a view showing the results of a precipitation amount evaluation test based on the amount of a stabilizer.

FIG. 14 is a view showing the results of a flavor test by light irradiation.

FIG. 15 is a view showing the results of a flavor test with and without enzyme mixture.

FIG. 16 is a view showing the results of a precipitation amount evaluation test with and without enzyme mixture.

### DESCRIPTION OF EMBODIMENTS

As used herein, the term “concentrated coffee” refers to coffee beverages and the like diluted with hot water, cold water, milk, or the like for drinking by general consumers. As used herein, the term “coffee beverage and the like” refers to a beverage made from coffee beans and adding therein sugars, dairy products, emulsified edible oils and fats, and other ingredients and material sealed in a container, relative to coffee, coffee drinks, soft drinks containing coffee, and decaffeinated coffee.

As used herein, the term “flavor” is synonymous with, in other words, savor and refers to all-around senses such as taste, smell when put into the oral cavity.

As used herein, “mouthfeel” refers to all-around senses such as tactile sensations perceived in the oral cavity.

### 1. Concentrated Coffee in Single-Serving Container

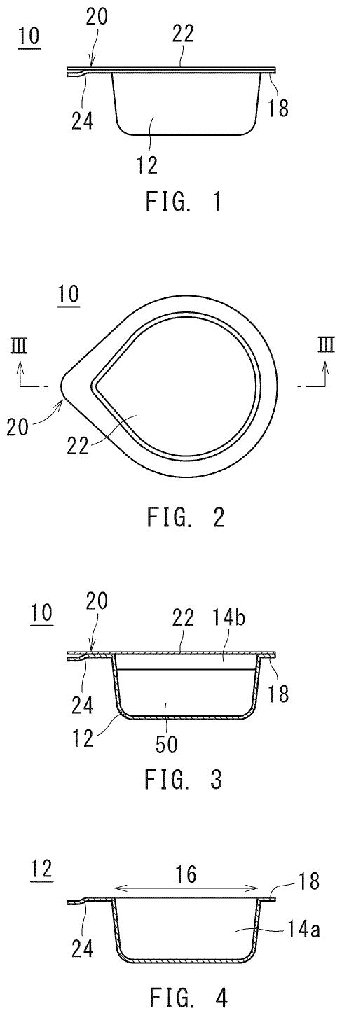

The concentrated coffee in single-serving container according to the present invention will be described with reference to FIGS. 1 to 4. FIG. 1 is an illustrative front view of the concentrated coffee in single-serving container according to an embodiment of the present invention. FIG. 2 is an illustrative plan view of the concentrated coffee in single-serving container according to an embodiment of the present invention. FIG. 3 is an illustrative cross-sectional view of the concentrated coffee in single-serving container taken along line III-III in FIG. 2. FIG. 4 is an illustrative cross-sectional view of the single-serving container taken along line III-III of FIG. 2.

A concentrated coffee 10 in single-serving container according to the present invention is such that an accommodation part 14a of a cup-shaped single-serving container 12 is filled with a predetermined amount of a concentrated coffee liquid 50 corresponding to the volume of the accommodation part 14a, and an opening 16 of the accommodation part 14a is sealed with a peelable lid material 22. In addition, a space 14b other than the concentrated coffee liquid 50 filled in the accommodation part 14a of the single-serving container 12 sealed with the lid material 22 is filled with an inert gas.

### (Single-Serving Container)

The single-serving container 12 according to the present invention is, for example, a cup-shaped container having the opening 16 in one of a cylindrical shape and a truncated cone shape. Further, the single-serving container 12 is provided with an accommodation part 14a for filling contents. A flange portion 18 is provided on the periphery of the opening 16 of the accommodation part 14a. The flange portion 18 is a portion for attaching the lid material 22. The single-serving container 12 and the lid material 22 are heat-sealed at the flange portion 18 of the single-serving container 12, and the lid material 22 is formed so as to block the opening 16 of the accommodation part 14a. Further, a tab portion 20 is formed extending outward from one end of the flange portion 18. A step portion 24 is formed from the center to the tip of the tab portion 20. The step portion 24 is configured to facilitate removing of the lid material 22 from the flange portion 18.

The volume of the accommodation part 14a of the single-serving container 12 is, for example, 4 ml or more and 13 ml or less. The volume of the concentrated coffee liquid 50 to be filled in the accommodation part 14a of the single-serving container 12 varies depending on the concentration rate of the concentrated coffee liquid 50, and for example, when diluting to 11 to 13-fold with hot water, cold water, milk, and the like to prepare approximately 120 ml of a coffee liquid, the filling amount of the concentrated coffee liquid 50 is preferably 9.5 ml to 10.5 ml. With the volume of the accommodation part 14a of the single-serving container 12 set to, for example, 13 ml, the amount of the concentrated coffee liquid 50 for single use can be filled.

The single-serving container 12 is formed from a material having a gas barrier property. The single-serving container 12 having the gas barrier property to block gases (oxygen, water vapor, etc.) can prevent oxygen and moisture from flowing into the accommodation part 14a of the single-serving container 12, and the filled inert gas and coffee aroma components can be prevented from flowing out. For example, the material of the single-serving container 12 may be a four-layer structure in which a polypropylene layer, an ethylene-vinyl alcohol copolymer (EVOH) resin layer, a polypropylene layer, and a polyethylene layer are laminated in this order. The ethylene-vinyl alcohol copolymer (EVOH) resin is a material having a gas barrier property. Providing an ethylene-vinyl alcohol copolymer (EVOH) resin between polypropylene layers facilitates molding into a single-serving container. Furthermore, the single-serving container 12 is preferably a light-shielding material. For example, coloring the polypropylene layer of the single-serving container 12 enables a light shielding property to be imparted. Filling the concentrated coffee liquid 50 in the accommodation part 14a of the single-serving container 12 having a light-shielding property can prevent deterioration of the concentrated coffee liquid 50 due to light.

### (Lid Material)

The lid material 22 is sealed to the opening 16 of the single-serving container 12 and provided peelably. The lid material 22 is formed from a material having a gas barrier property. The lid material 22 having a gas barrier property to block gases (oxygen, water vapor, etc.) can prevent oxygen and moisture from flowing into the accommodation part 14a of the single-serving container 12, and also prevent the filled inert gas and coffee aroma components from flowing out. The material of the lid material 22 is preferably a sheet obtained by laminating polyethylene, polyethylene terephthalate, or the like on a surface of aluminum, for example. The material of the lid material 22 may have, for example, a six-layer structure in which a polyethylene terephthalate layer, a printed layer, an aluminum layer, a polyethylene layer, the polyethylene terephthalate layer and the polyethylene layer are laminated in this order. Furthermore, the lid material 22 is preferably a material having a light shielding property. The accommodation part 14a of the single-serving container 12 is sealed with the lid material 22 after filling the accommodation part 14a of the single-serving container 12 with the concentrated coffee liquid 50, so that deterioration of the concentrated coffee liquid 50 due to light can be prevented. For example, using an aluminum sheet for the lid material 22 can impart a light shielding property. The single-serving container 12 and the lid material 22 are hermetically sealed by heat-sealing the polypropylene layer of the single-serving container 12 and the polyethylene layer of the lid material 22.

### (Concentrated Coffee)

The concentrated coffee liquid 50 to be filled in the accommodation part 14a of the single-serving container 12 according to the present invention can be obtained by mixing an unprocessed concentrated coffee liquid 52 and the stabilizer 54 together. The unprocessed concentrated coffee liquid 52 is produced, for example, by roasting coffee beans, extracting with water, and concentrating by evaporating water. The conditions such as types of coffee beans, roasting conditions, extraction conditions used to produce the unprocessed concentrated coffee liquid 52 are not particularly limited, and can be determined as desired or necessary. concentration rate of the unprocessed concentrated coffee liquid 52 is, for example, 23 times. Furthermore, the concentrated coffee liquid 50 may be added with sugars, dairy products, emulsified edible oils and fats, and the like. A filling amount of the concentrated coffee liquid 50 is preferably 56% or more and 81% or less of the volume of the single-serving container 12. In this way, a space 14b can be sufficiently provided by adjusting the filling amount, so that the concentrated coffee liquid 50 can be prevented from spilling when unsealed.

Also, the stabilizer 54 contained in the concentrated coffee liquid 50 is, for example, microcrystalline cellulose. Microcrystalline cellulose is purified by partially depolymerizing α-cellulose obtained from fibrous plants with an acid. Microcrystalline cellulose is a polysaccharide that does not completely dissolve in water, but when particles of the microcrystalline cellulose swell and create a mesh-like network each other, the particles disperse and float in water, exhibiting a suspension stabilizing effect. Therefore, mixing microcrystalline cellulose as a stabilizer 54 into the unprocessed concentrated coffee liquid 52 can be prevented from precipitation of the concentrated coffee liquid 50. The concentrated coffee liquid 50 is preferably mixed with the stabilizer 54 at a ratio of 0.54% or more and 0.83% or less with respect to the unprocessed concentrated coffee liquid 52. By mixing in such a ratio, precipitation can be prevented without affecting the flavor.

### (Space)

The space 14b of the single-serving container 12 according to the present invention is a space other than the concentrated coffee liquid 50 filled in the accommodation part 14a of the single-serving container 12 sealed with the lid material 22. For example, the space 14b can be provided with a volume of 19% or more and 44% or less of the volume of the accommodation part 14a of the single-serving container 12. Providing the space 14b in the accommodation part 14a of the single-serving container 12 can prevent the concentrated coffee liquid 50 from spilling at the time of opening.

In addition, the space 14b is filled with an inert gas. The inert gas is, for example, nitrogen gas, carbon dioxide gas, argon gas, a mixture of nitrogen gas and carbon dioxide gas, or the like. While oxygen is usually contained approximately 21% in the air, and filling the space 14b with an inert gas allows the residual oxygen concentration in the space 14b to be less than 1% when the product is completed. Therefore, the deterioration of the concentrated coffee liquid 50 due to oxidation in a predetermined best-before date can be prevented. Here, the predetermined best-before date means “a due date that is confirmed all expected qualities can be sufficiently maintained when stored in a predetermined manner”. The oxygen in the single-serving container 12 is removed by filling the space 14b of the single-serving container 12 with an inert gas, which prevents the oxidation of the concentrated coffee liquid 50 from progressing.

### (Effect)

According to the concentrated coffee 10 in the single-serving container of the present invention, since the single-serving container 12 is provided with the space 14b other than the concentrated coffee liquid 50, the concentrated coffee liquid 50 can be prevented from spilling when unsealed. Filling the space 14b of the accommodation part 14a of the single-serving container 12 with an inert gas can prevent deterioration due to oxidation of the filled concentrated coffee liquid 50.

In addition, the concentrated coffee liquid 50 is mixed with the stabilizer 54, which can prevent precipitation. Since precipitation of the concentrated coffee liquid 50 can be prevented, the mouthfeel when drinking can be improved, and the preservability can also be improved.

Furthermore, the single-serving container 12 and the lid material 22 are formed from a material having a gas barrier property, which can prevent the inflow of oxygen and prevent the leakage of the distinctive aroma components of coffee to the outside of the single-serving container 12, therefore, the distinctive flavor of coffee can be preserved for a long time. Further, using a light-shielding material for the single-serving container 12 and the lid material 22 can prevent deterioration due to light.

### 2. Method For Manufacturing Concentrated Coffee in Single-Serving Container

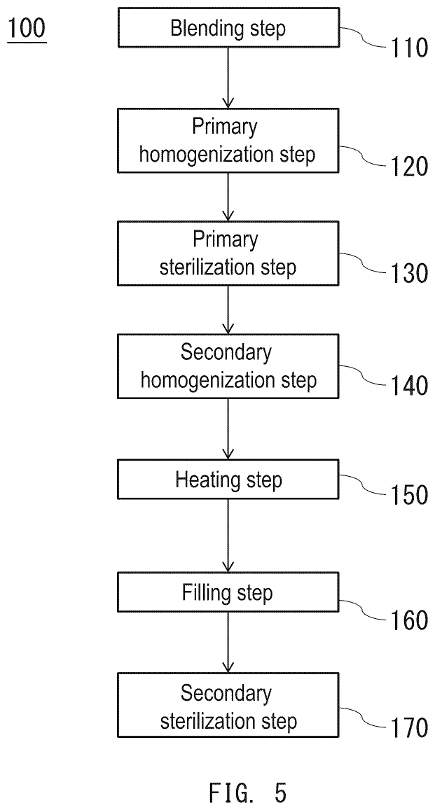

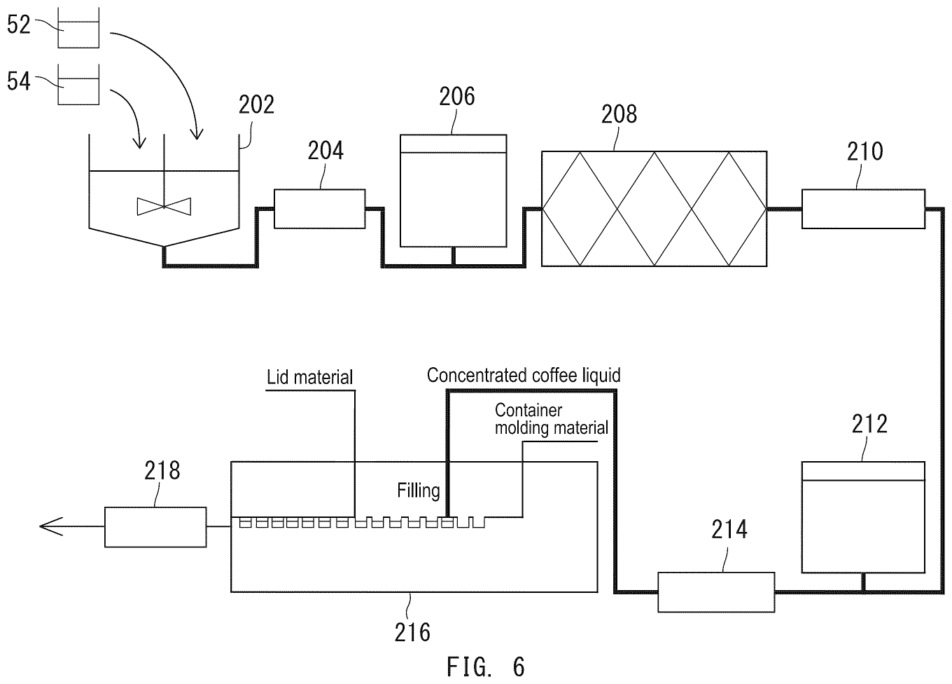

The method for manufacturing a concentrated coffee in single-serving container according to the present invention will be described with reference to FIGS. 5 and 6. FIG. 5 is a flow chart showing the method for manufacturing the concentrated coffee in single-serving container according to an embodiment of the present invention. FIG. 6 is an illustrative view showing the method for manufacturing the concentrated coffee in single-serving container according to an embodiment of the present invention.

A method 100 for manufacturing a concentrated coffee in single-serving container according to an embodiment of the present invention includes the following seven steps.
(1) Blending step
(2) Primary homogenization step
(3) Primary sterilization step
(4) Secondary homogenization step
(5) Heating step
(6) Filling step
(7) Secondary sterilization step

The details of each step will be described below.

### (1) Blending Step

First, in a blending tank 202, an unprocessed concentrated coffee liquid 52 is mixed with a stabilizer 54 to prepare a concentrated coffee liquid 50 (blending step 110). The stabilizer 54 is dispersed in cold water or warm water. To prevent thermal degradation of the unprocessed concentrated coffee liquid 52, the stabilizer 54 is preferably dispersed in cold water or warm water. The dispersed stabilizer 54 is mixed into the unprocessed concentrated coffee liquid 52 without frothing. This is because frothing in mixing the stabilizer 54 and the unprocessed concentrated coffee liquid 52 brings inefficiency of homogenization will deteriorate. After the blending step 110, the mixture is stirred at a low speed. After mixing the unprocessed concentrated coffee liquid 52 and the stabilizer 54, the concentrated coffee liquid 50 is fed into a pipe equipped with a line filter to remove impurities.

### (2) Primary Homogenization Step

The mixed concentrated coffee liquid 50 is homogenized (primary homogenization step 120). The concentrated coffee liquid 50 obtained in the blending step 110 is fed to a first homogenizer 204 through a water supply pipe and pressurized for homogenization. By performing a homogenization step prior to a primary sterilization step 130, which will be described later, the particles are homogenized and the stabilizer 54 is completely dispersed to improve the stability effect. After homogenizing the concentrated coffee liquid 50, the concentrated coffee liquid 50 is fed into a pipe provided with a metal trap to remove metallic impurities. After that, the concentrated coffee liquid 50 is temporarily stored in a cushion tank 206.

### (3) Primary Sterilization Step

The primarily homogenized concentrated coffee liquid 50 is sterilized (primary sterilization step 130). The sterilization treatment can be performed using a plate-type sterilizer, a tube-type sterilizer, or the like. The concentrated coffee liquid 50 obtained by the primary homogenization step 120 is continuously fed through a pipe to a plate-type sterilizer 208, and the concentrated coffee liquid 50 is preferably sterilized at 120° C. to 150° C. for 1 second to 5 seconds. In this way, performing the ultra-high temperature instantaneous sterilization treatment (UHT treatment) with the plate-type sterilizer 208, sterilization can be performed without impairing the coffee flavor. In addition, impurities are preferably removed by feeding the concentrated coffee liquid 50 into a pipe provided with a line filter before performing the primary sterilization step 130. The line filter used at this time preferably has a mesh size finer than the line filter used after mixing. Removing fine impurities before the primary sterilization step 130, the concentrated coffee liquid 50 can be sterilized efficiently.

### (4) Secondary Homogenization Step

The concentrated coffee liquid 50 performed the primary sterilization treatment is homogenized (secondary homogenization step 140). The concentrated coffee liquid 50 obtained by the primary sterilization step 130 is fed to a second homogenizer 210 through a water supply pipe and pressurized for homogenization. A secondary homogenization step 140 performed after the primary sterilization step 130 enables the particles to rehomogenized. Therefore, precipitation of the concentrated coffee liquid 50 is less likely to occur, and the stability of the concentrated coffee liquid 50 can be further improved. After the secondary homogenization step 140, the concentrated coffee liquid 50 is cooled and temporarily stored in a holding tank 212.

### (5) Heating Step

The concentrated coffee liquid 50 performed the secondary homogenization treatment is heated using a heat exchanger 214 (heating step 150). Heating is carried out, for example, by plate heating or by applying steam or the like to a tank containing the concentrated coffee liquid 50 to raise the temperature of the entire tank. Heating the concentrated coffee liquid 50 by plate heating can be instantaneously heated, so that quality deterioration due to heating can be prevented. The outlet temperature of the concentrated coffee liquid 50 is preferably controlled at 60° C. or higher and 85° C. or lower when outflowing the heat exchanger 214. Also, after heating the concentrated coffee liquid 50, the concentrated coffee liquid 50 is fed into a pipe provided with a metal trap to remove metallic impurities. Then, impurities in the concentrated coffee liquid 50 are removed using a conical filter.

### (6) Filling Step

Using a filling device 216, the container molding material 300 is press-formed, vacuum-formed, pressure-formed, or the like to form the accommodation part 14a of the single-serving container 12, and the concentrated coffee liquid 50 is filled into the accommodation part 14a. After filling the container 14a with the concentrated coffee liquid 50, an inert gas is injected to the accommodation part 14a. As a result, the air in the space 14b is replaced with the inert gas. Then, the single-serving container 12 and the lid material 22 are heat-sealed and formed into a final shape (filling step 160). The filling amount of the concentrated coffee liquid 50 to be filled in the accommodation part 14a of the single-serving container 12 is preferably 56% or more and 81% or less of the volume of the container. For example, when the volume of the single-serving container 12 is 13 ml, it is preferable to fill the concentrated coffee liquid 50 of 7.3 ml or more and 10.5 ml or less.

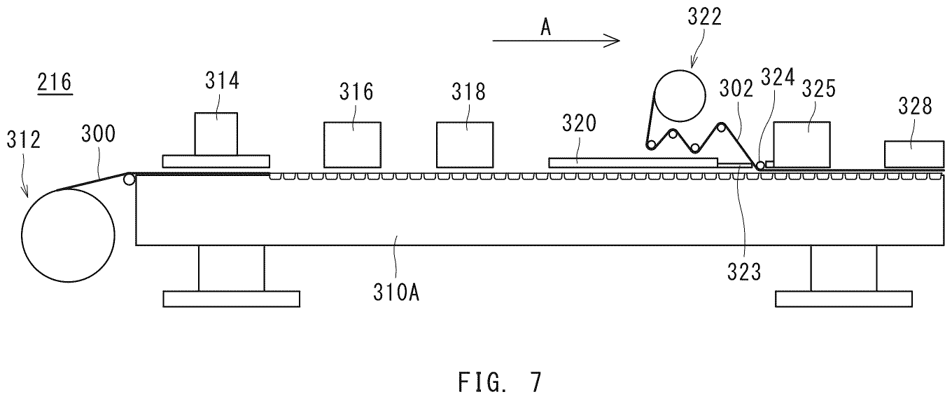

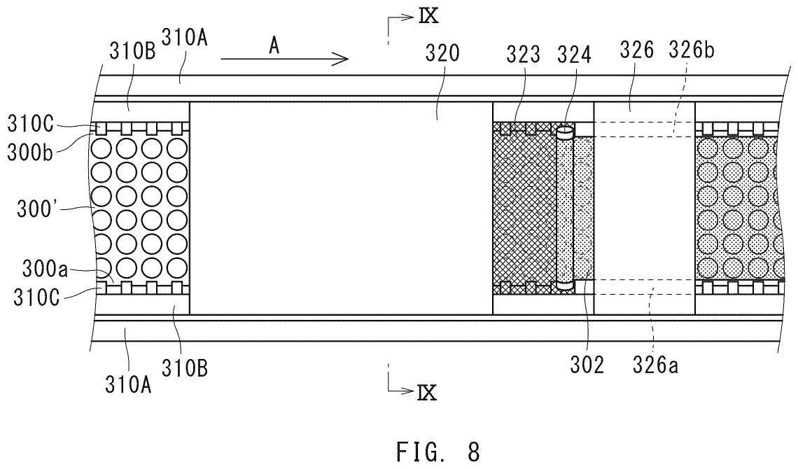

A step 160 for filling a concentrated coffee in single-serving container according to an embodiment of the present invention will be described with reference to FIGS. 7 and 8. FIG. 7 is an illustrative view showing a device for filling a concentrated coffee in single-serving container according to an embodiment of the present invention. FIG. 8 is an illustrative plan view of the device for filling the concentrated coffee in single-serving container according to an embodiment of the present invention.

As shown in FIGS. 7 and 8, a filling device 216 for filling a concentrated coffee in single-serving container according to an embodiment of the present invention has a heating mechanism 314 for heating and softening a container molding material 300 in order to form a single-serving container 12, a container molding mechanism 316 for molding the single-serving container 12 from the softened container molding material 300, a filling mechanism 318 for filling the single-serving container 12 with the concentrated coffee liquid 50, an inert gas replacement mechanism 320 for injecting an inert gas into the space 14b of the accommodation part 14a of the single-serving container 12 to replace the air in the space 14b with the inert gas, a sealing mechanism 326 for heat-sealing a lid material 302 to the single-serving container 12, and a punching mechanism 328 for cutting a container arranging sheet 300′ (container molding material 300) and a lid material 302 to form into a predetermined shape. Here, the flow direction A in which the single-serving container 12 molded from the container molding material 300 advances is the direction from the heating mechanism 314 to the punching mechanism 328.

The heating mechanism 314, the container molding mechanism 316, the filling mechanism 318, the inert gas replacement mechanism 320, the sealing mechanism 326, and the punching mechanism 328 of the filling device 216 for the concentrated coffee in single-serving container are provided in a machine frame 310A of the filling device 216 for a concentrated coffee in single-serving container. A pair of frames 310B are provided on the sides of the machine frame 310A along the flow direction A in which the single-serving container 12 advances. The container molding material 300 is conveyed by pulling out the container molding material 300, clamping both ends 300a and 300b of the container molding material 300 with clips 310C, and conveying the clips 310C along the pair of frames 310B.

The step 160 of filling the concentrated coffee in single-serving container will be described with reference to FIG. 7.

The step 160 of filling the concentrated coffee in single-serving container according to an embodiment of the present invention includes the following six steps.
(i) A step of molding the single-serving container 12
(ii) A step of filling a predetermined amount of a concentrated coffee liquid 50 into the accommodation part 14a of the single-serving container 12
(iii) A step of injecting an inert gas into the single-serving container 12 filled with the concentrated coffee liquid 50 to replace the air in the space 14b of the accommodation part 14a with the inert gas
(iv) A step of covering the opening 16 of the accommodation part 14a with the lid material 22
(v) A step of heat-sealing the lid material 22 to the flange portion 18 provided in the opening 16 of the accommodation part 14a
(vi) A step of punching out the single-serving container 12

The details of each step will be described below.

### (i) A Step of Molding the Single-Serving Container 12

First, the container molding material 300 is pulled out from a container molding material supply mechanism 312, and the container molding material 300 is heated using the heating mechanism 314 to soften the container molding material 300. Next, the single-serving container 12 is formed from the softened container molding material 300 in the container molding mechanism 316.

The container molding material 300 is the material of the single-serving container 12 formed into a sheet. The container molding material 300 has a four-layer structure in which, for example, a polypropylene layer, an ethylene-vinyl alcohol copolymer (EVOH) resin layer, a polypropylene layer, and a polyethylene layer are laminated in this order, and is formed in a band shape. The container molding material 300 is wound into a roll, and the container molding material 300 is pulled out, and both ends 300a and 300b of the container molding material 300 are clamped by clips 310 C, and the container molding material 300 is conveyed to the heating mechanism 314.

The heating mechanism 314 heats the container molding material 300 from both upper and lower sides by heaters to soften the container molding material 300.

The container molding mechanism 316 forms a container arranging sheet 300′ in which a plurality of single-serving containers 12 are formed at one time by press molding, vacuum molding, pressure molding, or the like from the softened container molding material 300. The container molding mechanism 316 can form, for example, 24 the single-serving containers 12 at a time. Further, the molding speed of the single-serving containers 12 by the container molding mechanism 316 is, for example, 360 to 432 pieces per minute.

(ii) A Step of Filling a Predetermined Amount of a Concentrated Coffee Liquid 50 into the Accommodation Part 14a of the Single-Serving Container 12

The filling mechanism 318 fills the single-serving container 12 formed by the container molding mechanism 316 with the concentrated coffee liquid 50. The filling amount of the concentrated coffee liquid 50 to be filled in the accommodation part 14a of the single-serving container 12 is preferably 56% or more and 81% or less of the volume of the container. Adjusting the filling amount in this way can provide a sufficient space 14b, so that the concentrated coffee liquid 50 can be prevented from spilling when unsealed. Further, the concentrated coffee liquid 50 is preferably filled at 60°° C. or higher and 80° C. or lower of a liquid temperature. By setting the liquid temperature of the concentrated coffee liquid 50 to such temperature conditions, thermal expansion of the single-serving container 12 can be prevented in a secondary sterilization step 170 described later.

(iii) A Step of Injecting an Inert Gas Into the Single-Serving Container 12 Filled with the Concentrated Coffee Liquid 50 to Replace the Air in the Space 14B of the Accommodation Part 14a With an Inert Gas

The inert gas replacement mechanism 320 injects an inert gas into the space 14b of the accommodation part 14a of the single-serving container 12 filled with the concentrated coffee liquid 50 to replace the air in the space 14b with an inert gas. An inert gas injection port 320a is provided on the container arranging sheet 300′ side of the inert gas replacement mechanism 320.

The inert gas can use nitrogen gas, carbon dioxide gas, argon gas, a mixture of nitrogen gas and carbon dioxide gas, or the like. Reducing the residual oxygen concentration can prevent deterioration of the concentrated coffee liquid 50 due to oxidation. Also, the flow rate of the inert gas is preferably 30 L/min or more and 70 L/min or less. This is because the inert gas flow rate of 30 L/min or less brings the inert gas flow rate to be small, and the residual oxygen concentration in the space 14b does not meet less than 1% when the product is completed, while the inert gas flow rate of 70 L/min or more brings the inert gas flow rate to be large, and the concentrated coffee liquid 50 filled in manufacturing may scatter. These conditions can prevent the concentrated coffee liquid 50 filled in the single-serving container 12 from scattering and can appropriately replace the air in the space 14b with inert gas. Furthermore, the replacement time is preferable in 7 seconds or longer. The replacement time is the time when the opening 16 of the single-serving container 12 is positioned below the injection port 320a of the inert gas replacement mechanism 320. When the opening 16 of the accommodation part 14a is positioned below the injection port 320a of the inert gas replacement mechanism 320, the inert gas is jetted for 7 seconds or more, so that the residual oxygen concentration in the space 14b of the accommodation part 14a can be less than 1% when the product is completed.

In this embodiment, the interior of the inert gas replacement mechanism 320 is divided into three chambers, and the inert gas is continuously injected into each chamber. Therefore, replacement of the air in the space 14b with the inert gas occurs three times for each single-serving container 12. In this embodiment, each single-serving container 12 is replaced with an inert gas three times, but the number of times of replacement is not limited. That is, the inert gas may be jetted to the accommodation part 14a of each single-serving container 12 one or more times to replace the air in the space 14b of each accommodation part 14a with the inert gas. By injecting an inert gas into the accommodation parts 14a of the single-serving containers 12 a plurality of times, the air in the space 14b can be efficiently replaced with the inert gas.

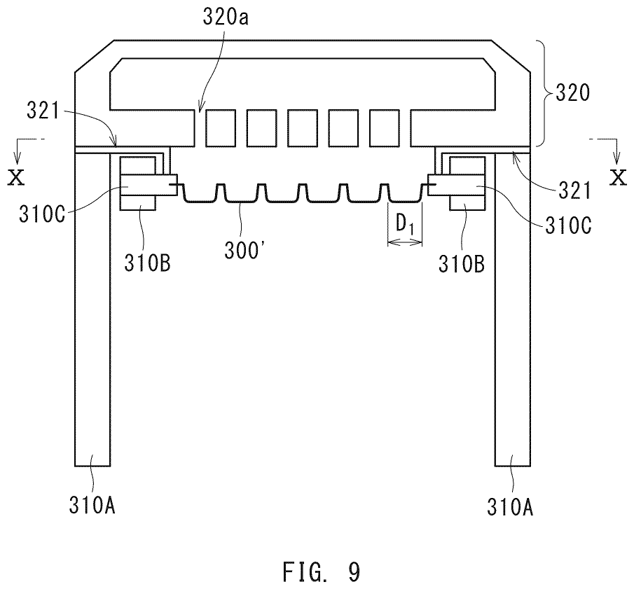

FIG. 9 is an illustrative cross-sectional view taken along line IX-IX in FIG. 8. The injection port 320a is provided so as to inject the inert gas into each of the single-serving containers 12.

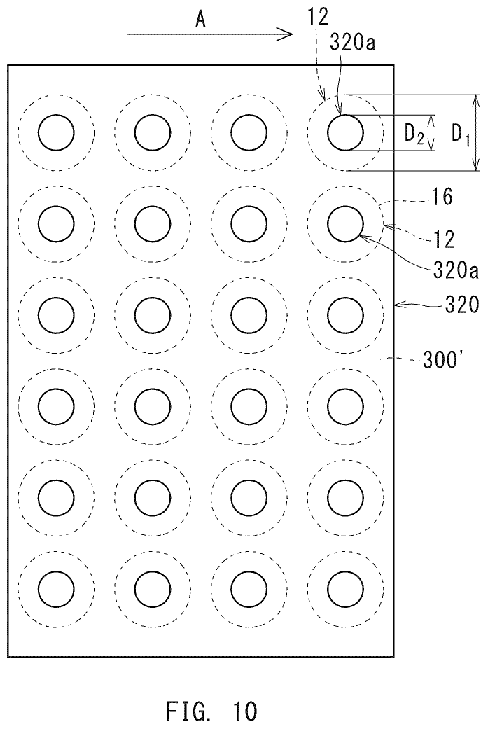

FIG. 10 is an illustrative cross-sectional view taken along line X-X in FIG. 9. In FIG. 10, the solid line portions indicate the injection port 320a provided in the inert gas replacement mechanism 320, and the broken line portions indicates the opening 16 of the accommodation part 14a of the single-serving container 12. As shown in FIG. 10, the diameter D₂ of the injection port 320a is preferably smaller than the diameter D₁ of the single-serving container 12. By having such an injection port 320a, the air in the space 14b can be efficiently replaced with an inert gas.

In addition, the inert gas replacement mechanism 320 preferably includes an inert gas leakage prevention part 321 for preventing an inert gas from escaping from both ends 300a and 300b in the same direction as the flow direction A of the container arranging sheet 300′. The inert gas leakage prevention part 321 is, for example, an L-shaped metal fitting. The inert gas leakage prevention part 321 is fixed by being sandwiched between the machine frame 310A and the inert gas replacement mechanism 320. Further, the inert gas leakage prevention part 321 prevents the inert gas injected from the injection port 320a of the inert gas replacement mechanism 320 from escaping to the machine frame 310A side. By providing the inert gas leakage prevention part 321 in this way, the inert gas is prevented from escaping from between the clips 310C that sandwich both ends 300a and 300b of the container arranging sheet 300′, and air (oxygen) can be prevented from entering.

(iv) A Step of Covering the Opening 16 of the Accommodation Part 14a with the Lid Material 302

The lid material feeder 322 pulls out the lid material 302 wound in a roll shape, and supplies the lid material 302 from a roller 324 so as to cover the opening 16 of the accommodation part 14a of the single-serving container 12.

The lid material 302 has a six-layer structure in which, for example, a polyethylene terephthalate layer, a printed layer, an aluminum layer, a polyethylene layer, a polyethylene terephthalate layer, and a polyethylene layer are laminated in order, and is formed in a band shape.

In addition, between the inert gas replacement mechanism 320 and the roller 324 of the lid material feeder 322, an inert gas sealing mechanism 323 is preferably disposed to prevent an inert gas from escaping from between the inert gas replacement mechanism 320 and the roller 324, and to prevent air (oxygen) from entering from between the inert gas replacement mechanism 320 and the roller 324. The inert gas sealing mechanism 323 is sheet-like. The end portion of the inert gas sealing mechanism 323 on the flow direction A side is provided so as to be connected to guide mechanisms 326a and 326b of a sealing mechanism 326 without gaps. Since the container arranging sheet 300′ moves from the inert gas replacement mechanism 320 toward the roller 324 of the lid material feeder 322, the inert gas is moved from the inert gas replacement mechanism 320 toward the roller 324 of the lid material feeder 322. Therefore, by providing the inert gas sealing mechanism 323, the sealing between the inert gas replacement mechanism 320 and the roller 324 of the lid material feeder 322 can be improved.

### (v) A Step of Heat-Sealing the Lid Material 22 to the Flange Portion 18 Provided at the Opening 16 of the Accommodation Part 14a

The sealing mechanism 326 supplies the lid material 302 to the single-serving container 12 in which the air in the space 14b of the single-serving container 12 has been replaced with the inert gas by the inert gas replacement mechanism 320, and heat-seals the lid material 302 to the flange portion 18 provided on the periphery of the opening 16 of the accommodation part 14a of the single-serving container 12. The temperature for heat-sealing is, for example, 120°° C. to 215° C.

Furthermore, between the roller 324 of the lid material feeder 322 and the sealing mechanism 326, a pair of guide mechanisms 326a and 326b which guide both ends in the same direction as the flow direction A of the container arranging sheet 300′ so as to press both ends of the container arranging sheet 300′ and both ends of the lid material 302 are preferably provided. By providing the sealing mechanism 326 with a pair of guide mechanisms 326a and 326b, the sealability between the container arranging sheet 300′ and the lid material 302 can be improved, the leakage of an inert gas from between the container arranging sheet 300′ and the lid material 302 can be prevented, and the inflow of air (oxygen) from between the container arranging sheet 300′ and the lid material 302 can be prevented. The pair of guide mechanisms 326a and 326b are preferably made of a heat-resistant material, such as Teflon (registered trademark) (fluororesin).

### (vi) A Step of Punching Out the Single-Serving Container 12

A punching mechanism 328 is used to cut the container arranging sheet 300′ and the lid material 302 into a final shape.

The device 216 for filling the concentrated coffee in single-serving container according to an embodiment of the present invention fills and conveys the concentrated coffee liquid 50. Therefore, the conveying speed is preferable at a slow speed. The conveying speed is, for example, 3 m to 3.6 m/min. If the conveying speed is faster, the concentrated coffee liquid 50 may flow out of the single-serving container 12. If the concentrated coffee liquid 50 flows out of the single-serving container 12, the single-serving container 12 and the lid material 22 are difficult to heat-seal together at the sealing mechanism 326.

### (7) Secondary Sterilization Step

The concentrated coffee in single-serving container 10 filled with the concentrated coffee liquid 50 is subjected to boiling sterilization using a boiling sterilizer 218 at 85° C. or higher and 89° C. or lower for 35 minutes (secondary sterilization step 170). For sterilization, the concentrated coffee in single-serving container 10 is placed in a boiling sterilization tank under the above temperature conditions and sterilized. Sterilization can be performed by either batch type boiling sterilization in which buckets are immersed in the boiling sterilization tank and taken out after a certain period of time, or continuous boiling sterilization in which the buckets are passed through the boiling sterilization tank in a tunnel for sterilization.

Thus, the concentrated coffee in single-serving container 10 is manufactured. After that, the concentrated coffee in single-serving container 10 is weighed, and a plurality of the manufactured concentrated coffees in single-serving container 10 are packaged in an outer bag provided with a light-shielding film and shipped (packaging step). The light-shielding film is, for example, an aluminum vapor deposition film. Degradation due to light can be prevented by packaging the concentrated coffee in single-serving container 10 with a light-shielding film.

### (Effect)

According to the method 100 for manufacturing the concentrated coffee in single-serving container of the present invention, the space 14b other than the concentrated coffee liquid 50 is provided in the single-serving container 12, so that the concentrated coffee liquid 50 can be prevented from scattering at the time of opening. By filling the space 14b of the accommodation part 14a of the single-serving container 12 with an inert gas, deterioration due to oxidation of the packed concentrated coffee liquid 50 can be prevented. In addition, since the concentrated coffee liquid 50 is mixed with the stabilizer 54, precipitation of the concentrated coffee liquid 50 can be prevented. Since precipitation of the concentrated coffee liquid 50 can be prevented, the mouthfeel when drinking can be improved, and the preservability can also be improved. Furthermore, the accommodation part 14a of the single-serving container 12 and the lid material 22 are made of a material having a gas barrier property to prevent the inflow of oxygen and to prevent the distinctive aroma components of coffee from flowing outside of the single-serving container 12 and the lid material 22, therefore, the distinctive flavor of coffee can be preserved for a long period of time.

According to the method 100 for manufacturing the concentrated coffee in single-serving container of the present invention, the particles can be made uniform again by further performing the secondary homogenization step 140 after the primary sterilization step 130. Therefore, precipitation of the concentrated coffee liquid 50 is less likely to occur, and the stability of the concentrated coffee liquid 50 can be further improved.

According to the method 100 for manufacturing the concentrated coffee in single-serving container of the present invention, deterioration due to light can be prevented by packaging in an outer bag provided with a light-shielding film.

### (Modification)

In the filling step 160, although the steps from the step of molding the single-serving container 12 (i) to the step of heat-sealing the lid material 22 to the flange portion 18 provided at the opening 16 of the accommodation part 14a (v) can be carried out in an inert gas atmosphere, the air in the space 14b can be efficiently replaced with the inert gas by injecting an inert gas toward the accommodation part 14a of the single-serving container 12.

### EXAMPLES

Examples of the present invention will be described below by taking concentrated sugar-free black coffee in a single-serving container as an example. The present invention also includes coffee beverages such as concentrated sugar-containing coffee and coffee with milk, and is not limited to this embodiment.

A concentrated coffee in single-serving container 10 was manufactured by the following method.

First, microcrystalline cellulose (stabilizer 54) was dispersed in water at 50° C. to 70°° C. at a ratio of 0.83% with respect to an unprocessed concentrated coffee liquid 52, and mixed with the unprocessed concentrated coffee liquid 52 in the blending tank 202 to obtain a concentrated coffee liquid 50. After that, the concentrated coffee liquid 50 was passed through a line filter with a punching hole diameter of 0.35 mm (equivalent to 40 mesh) (blending step 110).

Next, the concentrated coffee liquid 50 obtained in a blending step 110 was fed into a first homogenizer 204 (manufactured by Sanwa Engineering Co., Ltd.) through a water supply pipe, and subjected to a pressure of 5 to 20 MPa for homogenization. After homogenization, the concentrated coffee liquid 50 was passed through a metal trap with a 800 mT or more/1 T magnet and stored in a cushion tank 206 (primary homogenization step 120).

Next, the concentrated coffee liquid 50 obtained in the primary homogenization step 120 was passed through a line filter with a punching hole diameter of 0.14 mm (equivalent to 80 mesh). Thereafter, the concentrated coffee liquid 50 was continuously sent through a pipe to a plate-type sterilizer 208 and sterilized at 120° C. to 150° C. for 1 second to 5 seconds (primary sterilization step 130).

Next, the concentrated coffee liquid 50 obtained in the primary sterilization step 130 was fed into a second homogenizer 210 (manufactured by Sanwa Engineering Co., Ltd.) through a water supply pipe, and homogenized by applying a pressure of 5 to 20 MPa. After the secondary homogenization treatment, the concentrated coffee liquid 50 was stored in a holding tank 212 (secondary homogenization step 140).

Next, the concentrated coffee liquid 50 obtained in the secondary homogenization step 140 was heated by a heat exchanger 214 to 60° C. to 85° C. The heated concentrated coffee liquid 50 was passed through a metal trap with a 800 mT or more/1 T magnet, and then passed through a conical filter of 120 mesh with a 0.13 mm mesh opening (heating step 150).

Next, using the filling device 216, 10 ml of the heated concentrated coffee liquid 50 was filled into the single-serving container 12 having a volume of 13 ml, and nitrogen as an inert gas was injected into the opening 16 of the single-serving container 12, to replace the air in the space 14b with nitrogen, and the lid material 22 (302) was heat-sealed to form a concentrated coffee in single-serving container 10 (filling step 160). Finally, the concentrated coffee in single-serving container 10 obtained in the filling step 160 was boiling sterilized in a boiling sterilizer 218 at 87° C. for 35 minutes (secondary sterilization step 170).

### 3. Experimental Data

The concentrated coffee in single-serving container 10 was manufactured according to the above manufacturing method, and the following tests were performed.

### (A) Long-Term Storage Test

The concentrated coffee in single-serving container 10 (Example) manufactured according to the above manufacturing method was stored at 37° C., and a flavor test was performed. As a comparative example, a concentrated coffee in single-serving container in which the air in the space 14b of the single-serving container 12 was not replaced with an inert gas (nitrogen) was stored under the same conditions, and a flavor test was performed. Note that storage at 37° C. for 20 weeks corresponds to storage at 23° C. for 369 days.

In the flavor test, a comprehensive evaluation was made from the six viewpoints of aroma, bitterness, sourness, sweetness, richness, and off-flavor/off-odor, and a good flavor was given a score of 5, followed by a score of 4 to 1 as the extent worsened, and the allowable range was set to 4 or more.

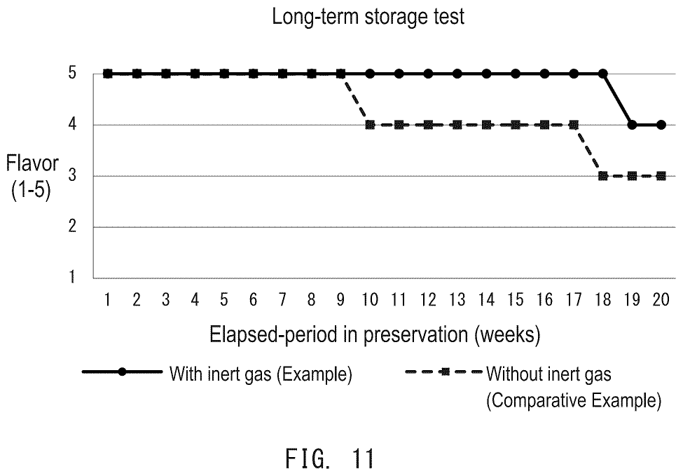

FIG. 11 shows the results of the long-term storage test.

As shown in FIG. 11, the concentrated coffee in single-serving container 10 manufactured following the manufacturing method according to the present invention (Example: with inert gas) could further prevent flavor deterioration. In the comparative example, the result was that the flavor deteriorated after 10 weeks (after about 185 days at 23° C.).

### (B) Flavor Test by Taste Sensor

The concentrated coffee in single-serving container 10 (Example) manufactured according to the above manufacturing method was stored under conditions of 15° C. and 24000 lux irradiation for 9 days. After that, analysis was performed with a taste sensor. The taste sensor used was a taste recognition device (TS-5000Z) manufactured by Intelligent Sensor Technology, Inc. In the analysis using the taste sensor, the measured potential in the reference solution of each taste sensor was set to zero, and the difference from the measured potential in the sample itself was the first taste (first taste: sourness, bitterness and off-taste, astringent stimulus, umami, salty taste), and after that, each taste sensor was lightly washed, and the potential difference when the reference solution was measured again was measured as the aftertaste (aftertaste: bitterness, astringency, umami richness). Note that storage for 9 days under the condition of irradiation of 24000 lux corresponds to storage for 300 days at a mass-market retailer (1500 lux).

Further, as Comparative Example 1, the concentrated coffee in single-serving container 10 (Example) was wrapped in aluminum foil and stored. In Comparative Example 1, only the light conditions were changed.

Furthermore, as Comparative Example 2, a concentrated coffee in single-serving container was manufactured in which the single-serving container 12 was formed from a material having no gas barrier property, and the space 14b of the single-serving container 12 was filled with air (not replaced with an inert gas), and the concentrated coffee was stored under the same conditions as in the example.

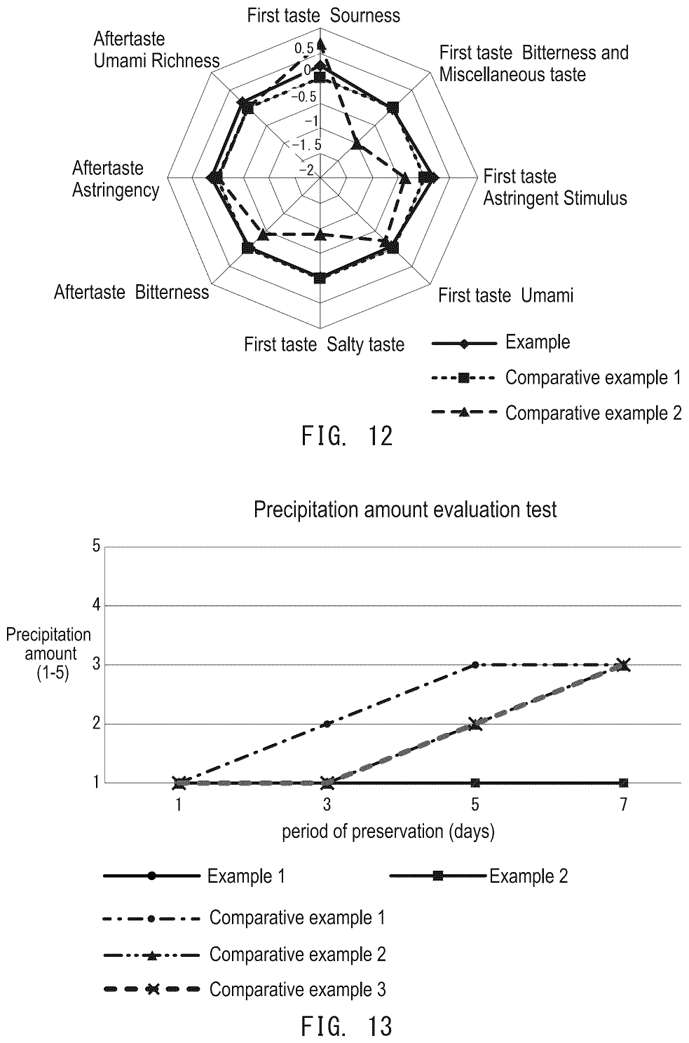

FIG. 12 shows the results of the flavor test using a taste sensor. The value of each inspection item in Comparative Example 1 was set to 0, and the relative values of each test item in Example and Comparative Example 2 were calculated.

As shown in FIG. 12, the example was able to maintain the same level of flavor as the comparative example 1 without any difference from the comparative example 1 (without light irradiation). In particular, while sourness, off-taste, and salty taste varied greatly in Comparative Example 2, the same flavor was maintained in Example as in Comparative Example 1.

### (C) Precipitation Amount Evaluation Test Based on Amount of Stabilizer

The mixed ratio of the unprocessed concentrated coffee liquid 52 and the stabilizer 54 was varied as described below, and stored standing at 50°° C., and the amount of precipitation was evaluated. Note that storage at 50° C. for 7 days corresponds to storage at 23° C. for 45 days. The case where no precipitation occurred was rated as 1, and then, as the amount of precipitation increased, it was rated from 2 to 5. The allowable range was only 1, and 2 or more was not allowed.

Example 1: 0.54% of stabilizer 54 is mixed with an unprocessed concentrated coffee liquid 52

Example 2: 0.83% of stabilizer 54 is mixed with an unprocessed concentrated coffee liquid 52

Comparative Example 1: 0% of stabilizer 54 is mixed with an unprocessed concentrated coffee liquid 52 (do not mix stabilizer)

Comparative Example 2: 0.27% of stabilizer 54 is mixed with an unprocessed concentrated coffee liquid 52

Comparative Example 3: 1.00% of stabilizer 54 is mixed with an unprocessed concentrated coffee liquid 52

FIG. 13 shows the results of the precipitation amount evaluation test based on the amount of stabilizer.

As shown in FIG. 13, when the stabilizer 54 was mixed with the unprocessed concentrated coffee liquid 52 at a ratio of 0.54% or more and 0.83% or less, no precipitation occurred during the test period. On the other hand, when the stabilizer 54 was mixed with the unprocessed concentrated coffee liquid 52 at a ratio of 0.27% or less, precipitation occurred. Moreover, when the stabilizer 54 was mixed with the unprocessed concentrated coffee liquid 52 at a ratio of 1.00% or more, the stabilizer 54 became excessive, and the stabilizer 54 itself caused precipitation.

### (D) Flavor Test by Light Irradiation

Three pieces of the concentrated coffee in single-serving container 10 manufactured according to the above manufacturing method were placed in an outer bag having an aluminum vapor-deposited film as an outer bag having a light shielding film (hereinafter referred to as an aluminum vapor-deposited bag) and stored (Example).

For the single-serving container 12 of the concentrated coffee in single-serving container 10, a container was used in which a light shielding property was imparted by coloring the polypropylene layer black. Also, the lid material 22 for the concentrated coffee in single-serving container 10 was used a lid material provided with a light-shielding property by providing an intermediate layer of aluminum foil. It was stored for 10 days under the conditions of 15° C. and 24000 lux irradiation, and a flavor test was performed. Note that storage for 10 days under the irradiation condition of 24000 lux corresponds to storage for 320 days at a mass-market retailer (1500 lux).

Further, as Comparative Example 1, the concentrated coffee in single-serving container 10 was placed in a transparent bag and stored. Except for the above, it was stored under the same conditions as in the example. As Comparative Example 2, the concentrated coffee in single-serving container that had not been replaced with nitrogen was placed in an aluminum vapor-deposited bag and stored. Except for the above, it was stored under the same conditions as in the example. As Comparative Example 3, a concentrated coffee in single-serving container that had not been replaced with nitrogen was placed in a transparent bag and stored. Except for the above, it was stored under the same conditions as in the example. In the flavor test by light irradiation, evaluation was performed from the six viewpoints of aroma, bitterness, sourness, sweetness, richness, off-taste/off-odor, as in the above test (A).

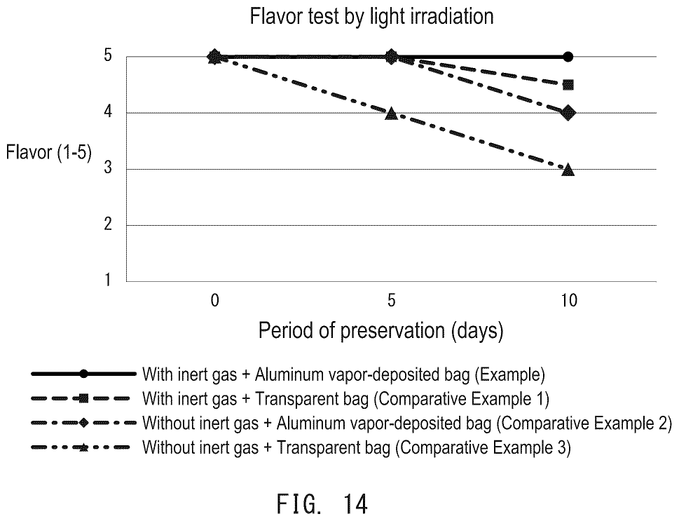

FIG. 14 shows the results of the flavor test by light irradiation.

As shown in FIG. 14, it was found that storage of the concentrated coffee in single-serving container 10 after nitrogen replacement in an aluminum vapor-deposited bag can prevent flavor deterioration. In particular, it was confirmed that deterioration due to light can be prevented more strongly by storing the concentrated coffee in single-serving container 10 that have been replaced with nitrogen in an aluminum vapor-deposited bag.

(E) Flavor Test with or without Enzyme Mixing

The concentrated coffee in single-serving container 10 manufactured according to the above manufacturing method (Example), a concentrated coffee in single-serving container in which no stabilizer was mixed with the concentrated coffee liquid (Comparative Example 1), and a concentrated coffee in single-serving container in which the concentrated coffee liquid was mixed with an enzyme (Comparative Example 2) were prepared, and stored at 5° C.

In Comparative Example 2, hemicellulase (10,000 units/g) was used as the enzyme. The enzyme was adjusted to be mixed with 0.005% of the concentrated coffee liquid.

In the flavor test with and without the enzyme mixing, evaluation was performed from the six viewpoints of aroma, bitterness, sourness, sweetness, richness, and off-taste/off-odor, as in the above test (A).

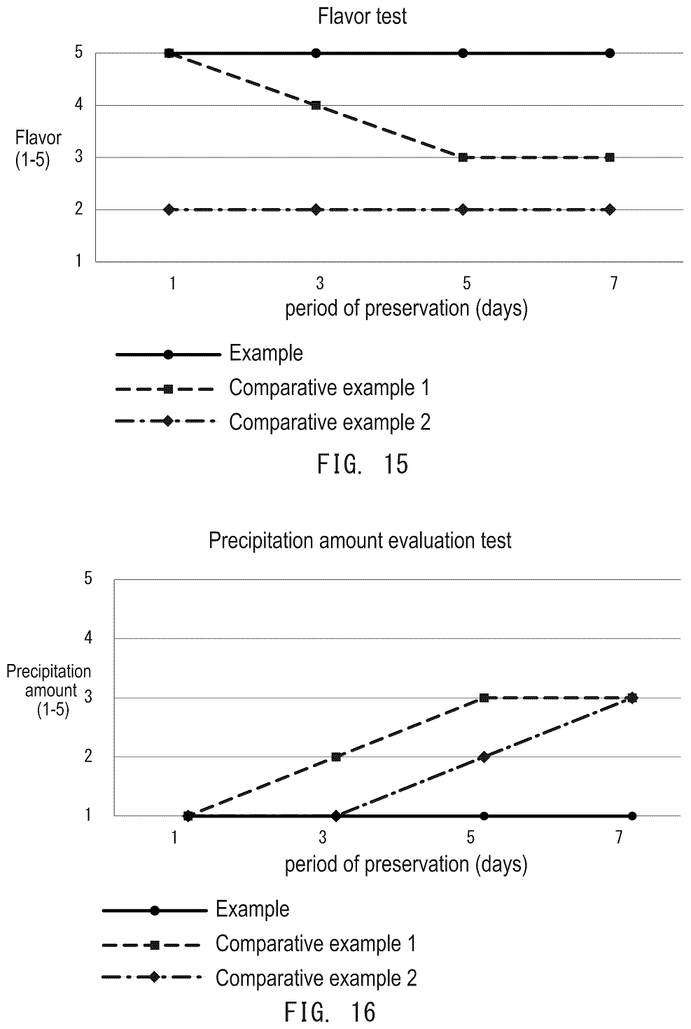

FIG. 15 shows the results of the flavor test with and without the enzyme mixing. As shown in FIG. 15, the concentrated coffee in single-serving container 10 (example) following manufactured the manufacturing method according to the present invention had better flavor compared to Comparative Examples 1 and 2.

(F) Precipitation Amount Evaluation Test with or without Enzyme Mixing

The concentrated coffee in single-serving container 10 manufactured according to the above manufacturing method (example), a concentrated coffee in single-serving container in which no stabilizer was mixed with the concentrated coffee liquid (Comparative Example 1), and a concentrated coffee in single-serving container in which the concentrated coffee liquid was mixed with an enzyme (Comparative Example 2) were prepared, and allowed to stand and stored at 50° C., and the precipitation amount was evaluated. Note that storage at 50° C. for 7 days corresponds to storage at 23° C. for 45 days.

In Comparative Example 2, hemicellulase (10,000 units/g) was used as the enzyme. The enzyme was adjusted to be mixed with 0.005% of the concentrated coffee liquid.

The case where no precipitation occurred was rated as 1, and then, as the amount of precipitation increased, it was rated from 2 to 5. The allowable range was only 1, and 2 or more was not allowed.

FIG. 16 shows the results of a precipitation amount evaluation test with and without enzyme mixing.

As shown in FIG. 16, the concentrated coffee in single-serving container 10 (example) manufactured following the manufacturing method according to the present invention resulted in less precipitation compared to Comparative Examples 1 and 2.

From the above results, it was confirmed that the concentrated coffee in single-serving container 10 manufactured by the above manufacturing method prevented flavor deterioration by replacing the air in the space 14b of the concentrated coffee in single-serving container 10 with an inert gas and maintained the quality until a predetermined expiration date.

Further, it was confirmed that precipitation of the concentrated coffee liquid 50 prevented without affecting the flavor of the concentrated coffee liquid 50 by mixing the concentrated coffee liquid 50 of the concentrated coffee in single-serving container 10 with microcrystalline cellulose as a stabilizer.

In addition, it was confirmed that by packaging and storing the concentrated coffee in single-serving container 10 according to the present invention in an outer bag having an aluminum vapor-deposited film as an outer bag having a light-shielding property, deterioration of the concentrated coffee liquid 50 due to light also prevented.

As described above, the embodiments of the present invention are disclosed in the above description, but the present invention is not limited thereto.

That is, without departing from the technical idea and the scope of purpose of the present invention, various modifications can be made to the above-described embodiments in terms of mechanism, shape, material, quantity, position, arrangement, etc. and they are included in the present invention.

### REFERENCE SIGNS LIST

10: concentrated coffee in single-serving container
12: single-serving container
14a: accommodation part
14b: space
16: opening
18: flange portion
20: tab portion
22: lid material
24: step portion
50: concentrated coffee liquid
52: unprocessed liquid coffee concentrate
54: stabilizer
100: method for manufacturing concentrated coffee in single-serving container
110: blending step
120: primary homogenization step
130: primary sterilization step
140: secondary homogenization step
150: heating step
160: filling step
170: secondary sterilization step
202: blending tank
204: first homogenizer
206: cushion tank
208: plate-type sterilizer
210: second homogenizer
212: holding tank
214: heat exchanger
216: filling device
218: boiling sterilizer
300: container molding material
300′: container arranging sheet
300a, 300b: both ends
302: lid material
310A: machine frame
310B: frame
310C: clip
312: container molding material supply mechanism
314: heating mechanism
316: container molding mechanism
318: filling mechanism
320: inert gas replacement mechanism
320a: injection port
321: inert gas leakage prevention part
322: lid material feeder
323: inert gas sealing mechanism
324: roller
326: sealing mechanism
326a, 326b: guide mechanism
328: punching mechanism
D₁: diameter of opening of accommodation part
D₂: diameter of injection port
A: conveying direction of container arranging sheet (flow direction)

1. A method for manufacturing a concentrated coffee in single-serving container in which a predetermined amount of a concentrated coffee liquid is filled in an accommodation part of a cup-shaped single-serving container, and the opening of the accommodation part is sealed with a peelable lid material comprising:
a blending step of mixing an unprocessed concentrated coffee liquid and a stabilizer to prepare the concentrated coffee liquid,
a homogenization step of homogenizing the concentrated coffee liquid obtained by the blending step,
a primary sterilization step of sterilizing the concentrated coffee liquid homogenized in the homogenization step,
a filling step of filling the concentrated coffee liquid sterilized in the primary sterilization step in the accommodation part molded of a container molding material having a gas barrier property, and sealing the opening of the accommodation part with the lid material having a gas barrier property, and
a secondary sterilization step of sterilizing the single-serving container filled with the concentrated coffee liquid in the filling step, wherein,
after filling the accommodation part of the single-serving container with the concentrated coffee liquid sterilized in the primary sterilization step, in the filing step, the space other than the concentrated coffee liquid in the accommodation part is filled with an inert gas, and then the opening of the accommodation part is sealed with the lid material.

2. The method for manufacturing the concentrated coffee in single-serving container according to claim 1, further comprising a secondary homogenization step of homogenizing the concentrated coffee liquid sterilized in the primary sterilization step, wherein the concentrated coffee liquid homogenized in the secondary homogenization step is filled in the filling step.

3. The method for manufacturing the concentrated coffee in single-serving container according to claim 1, wherein the stabilizer is mixed in the blending step at a ratio of 0.54% or more and 0.83% or less to the unprocessed concentrated coffee liquid.

4. The method for manufacturing the concentrated coffee in single-serving container according to claim 1, wherein the stabilizer is microcrystalline cellulose.

5. The method for manufacturing the concentrated coffee in single-serving container according to claim 1, further comprising a packaging step after the secondary sterilization step, wherein the packaging step includes a step of packaging a plurality of concentrated coffee in single-serving container in an outer bag having a light-shielding film.

6. A concentrated coffee in single-serving container in which a predetermined amount of a concentrated coffee liquid is filled in an accommodation part of a cup-shaped single-serving container, and the opening of the accommodation part is sealed with a peelable lid material, wherein the concentrated coffee liquid contains a stabilizer,
the single-serving container and the lid material are formed of a material having a gas barrier property,
the accommodation part is provided with a space other than the concentrated coffee liquid,
the space is filled with an inert gas, and the residual oxygen concentration is less than 1% in the space when the product is completed.

7. The concentrated coffee in single-serving container according to claim 6, wherein the single-serving container and the lid material are formed of a light-shielding material.

8. The concentrated coffee in single-serving container according to claim 6, wherein the concentrated coffee liquid includes an unprocessed concentrated coffee liquid and the stabilizer, and
the stabilizer is mixed at a ratio of 0.54% or more and 0.83% or less to the unprocessed concentrated coffee liquid.
